(19) United States
(12) Patent Application Publication
(10) Pub. No.: US 2002/0000434 A1
(43) Pub. Date: Jan. 3, 2002

(54) Radiant heating body for cooking hobs

(75) Inventors: Norbert Morsch, Wangen (DE); Jorg Meyer, Ratzenried (DE)

Correspondence Address: Leopold Presser, Scully, Scott, Murphy & Presser, 400 Garden City Plaza, Garden City, NY, 11530, US

(73) Assignee: Diehl AkO Stiftung & Co. KG, Wangen (DE)

(21) Appl. No.: 09/893,204

(22) Filed: Jun. 27, 2001

(30) Foreign Application Priority Data
Jun. 28, 2000 (DE) 200 11 315.1

(51) Int. Cl. H05B 3/74

(52) U.S. Cl. 219/461.1; 219/462.1

(57) ABSTRACT

The insulating bottom (3) of a metal foil radiant heating body for a cooking hob is provided with a holding portion by means of which an insulating ring is secured under a glass ceramic plate to delimit the heating zone. By virtue of being secured to that holding portion (4), a particularly narrow inner insulating ring can also be operationally reliably fixed on the insulating bottom (3) in order to distinguish an inner from an ouster cooking hob portion.

The invention concerns a radiant heating body for cooking hobs of twin-circuit heating arrangements, in particular glass ceramic cooking hobs, having heating conductors comprising a metal foil and insulating bottoms arranged under the heating conductors, wherein the heating conductors extend in a geometrical pattern between the respective cooking hob and the associated insulating bottom and the inner cooking hob of the twin-circuit heating arrangement is delimited by an inner ring of heat-insulating material.

DE 297 02 813 U1 already discloses a twin-circuit configuration of an electrical hot plate. The arrangement of the heating conductor paths or tracks is substantially radial but a central substantially circular feed line assembly is still provided between the outer and the inner feed line tracks. The particular arrangement involved makes it possible for only the central main heating zone alone to be switched on in order to heat a relatively small cooking vessel. At the same time however it is also possible for that main heating zone to be operated together with an outer additional heating zone which can be further switched on, in order to heat the full size of the electrical hot plate and accordingly to be able to heat a larger cooking vessel. In general with such twin-circuit heating arrangements the inner cooking hob portion is separated from the outer annular cooking hob portion by a heat-insulating inner ring.

The inner ring and also the outer insulating ring stand on an insulating bottom comprising a heat-insulating material.

The inner ring which in practice hitherto has been usually employed in twin-circuit heating arrangements is generally from 10 to 11 mm in cross-sectional width. The insulating properties resulting therefrom generally surpass the demands on the insulating ring by a multiple. Various investigations have now shown that a twin-circuit heating arrangement with an only thin-walled inner insulating ring is also suitable for practical use. For, the loss of efficiency when cooking is implemented only with the inner cooking zone and a small pot is negligibly low. A radiant heating body on a foil basis must make use of a maximum of heated surface area so that the loading in relation to surface area of the heating elements can be kept down. Otherwise, the element temperature rises, which entails a reduction in the service life. The inner ring of a twin-circuit heating arrangement now occupies valuable area. If that area can be reduced then it will be appreciated that it is possible to achieve higher power levels with the same element temperature.

In practice it has now been found that resting the inner ring or the outer ring on the insulating bottom alone is not sufficient. Various attempts have been undertaken to implement fixing of the inner ring on the insulating bottom, which constitutes an optimum fixing mode and which is also fully appropriate in operation.

In a radiant heating body for cooking hobs of the kind set forth in the opening part of this specification, the object of the invention is to provide an inner ring fixing for those twin-circuit heating bodies, which can be used both in relation to thin-walled inner rings and also in relation to normal-walled inner rings.

In accordance with the invention that object is attained by the features of claim 1. Advantageous configurations and developments of that general fixing are described in the appendant claims.

In accordance with the invention securing of the inner ring is effected in a simple and advantageous manner by the insertion of a simple holding portion between the contact surface of the inner ring and the facing annular surface of the insulating bottom. In that way the inner ring can be mechanically connected to the insulating bottom and the holding portion. Alternatively however it is also possible for the inner ring to be connected only to the holding portion.

A particular advantage is that the holding portion can have apertures at the pin positions, which for example permits different degrees of expansion in the event of a thermal loading as between the ring and the holding portion. It will be appreciated that the pin can also be fitted directly through the apertured holding portion. In that case, as a preliminary assembly step, the respective ring is positioned over the holding portion and the pins are shot through the holding portion into the ring. The resulting unit comprising the holding portion with heating foil and inner ring is fitted into the insulated holder bowl, in a subsequent production step.

In accordance with the features of the claims the inner ring of the twin-circuit heating arrangement is secured by means of a pin which engages through the holding portion into the insulating bottom. This simple holding portion also permits preliminary assembly steps in which the pins are shot into the ring through the holding portion which is positioned relative to the ring. The resulting unit consisting of the holding portion, the heating foil and the inner ring is then fitted into the insulated holder bowl in the second production step. The inner ring is then anchored by way of the projecting pins.

In accordance with the features of the claims, securing of a thin-walled inner ring is implemented by virtue of the provision of insertion tongues which are formed in one piece on the ring portion, the tongues being fitted into corresponding apertures in the holding portion in the assembly procedure. Such insertion tongues are provided with widened portions which impart a self-locking action to the connection.

Suitably shaped projections at the lower edge of the ring, with the slots provided for same in the holding portion, form a kind of bayonet fastener. By virtue of fitment of the bar expansion regulator which at two positions crosses the inner ring in corresponding apertures, that inner ring is secured to prevent rotation thereof and thus the connection is secured in such a way as to prevent unintentional release.

Due to the high temperature differences within a heating body and due to the different coefficients of thermal expansion of the various components, stressing or deformation of individual components can occur in a heating operation. Minor relative movements of the regions of the holding portion with respect to each other are permissible and can even be advantageous for the purposes of compensating for thermal expansion. The freedom from stress is achieved by cracks or splits which are formed in operation at a predefined location. The holding portion which is composed for example of the straight and the arcuate regions is integrally manufactured and assembled. Cross-sectional weakenings which are formed therein at defined locations act as desired-fracture locations which tear due to subsequent heat expansion forces. That permits small relative movements of the regions of the holding portion with respect to each other.

The different degrees of thermal expansion of the three holding limb regions are made possible by stamped-out slots which elastically connect the three zones relative to each other without major component stresses occurring.

The definitive resistance of a heating foil and thus the power which is delivered at rated voltage depends on the tolerance of the foil thickness, the heating limb width and the specific resistance of the initial material. If heating limbs are bridged over by the corresponding connection in foil production, then the resistance of a heating foil can be subsequently increased by cutting out bridges. That can be effected during the assembly procedure or in final testing and checking, by mechanical cutting, laser cutting, electrically burning therethrough by punctiform applied overvoltage, or the like.

An example of the invention is illustrated in the drawing in which:

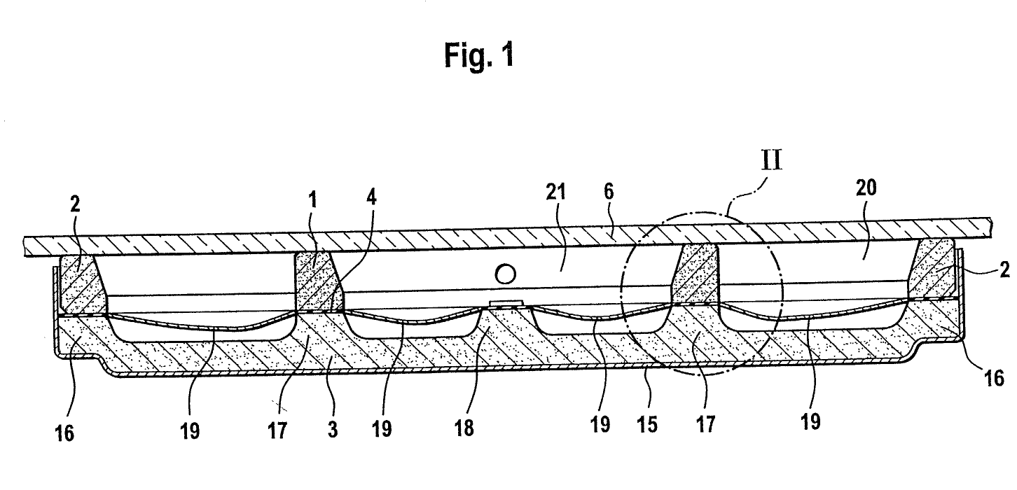

FIG. 1 is a view in section of a radiant heating body for cooking hobs of a twin-circuit heating arrangement,

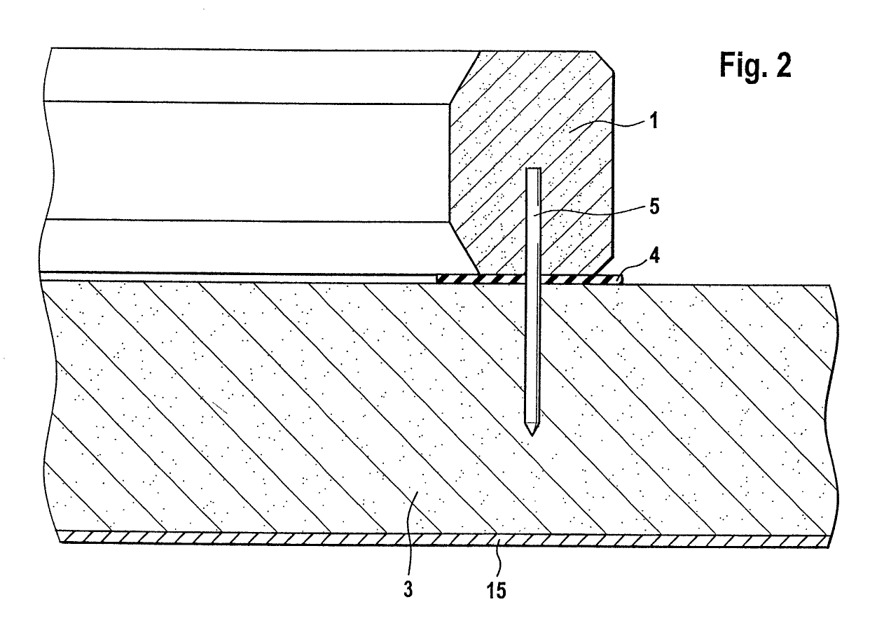

FIG. 2 is a view in section of a portion from FIG. 1 as indicated by the circle II,

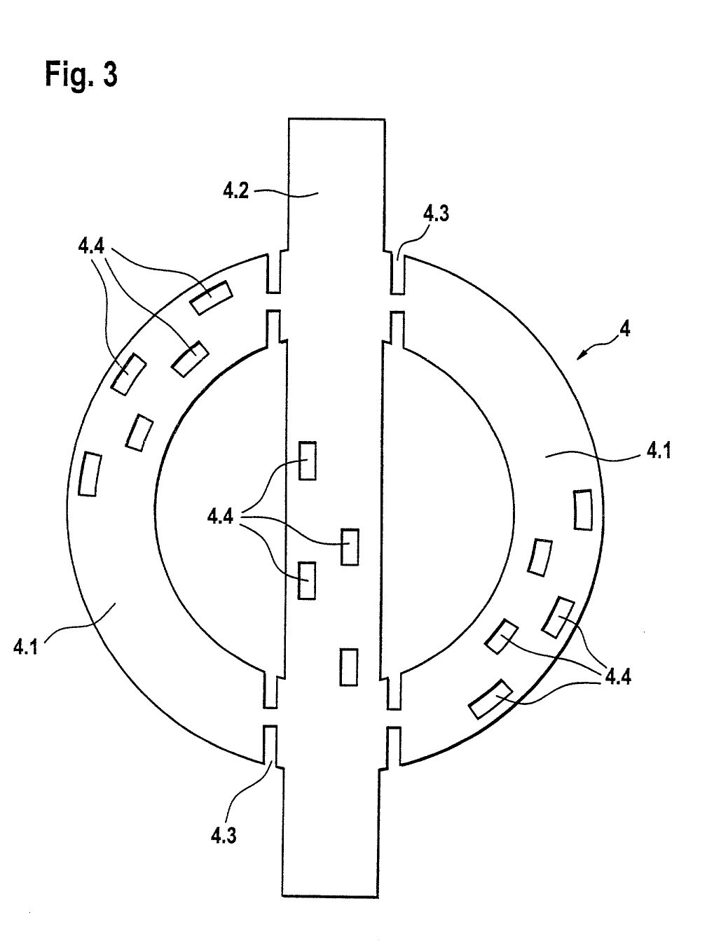

FIG. 3 shows a plan view of the holding portion,

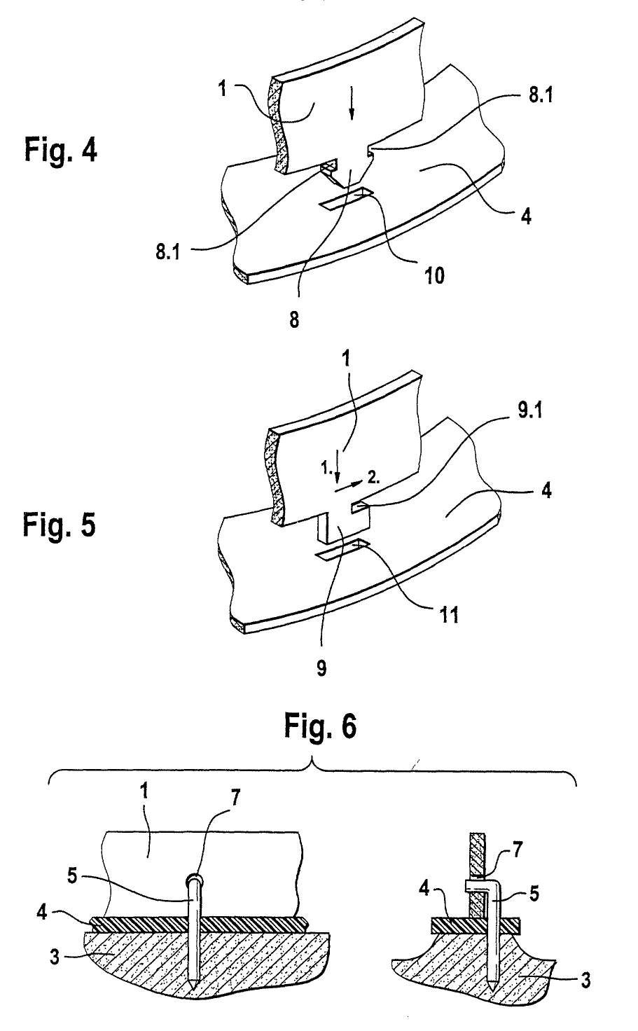

FIG. 4 shows a perspective view of a first manner of securing the inner ring to the holding portion,

FIG. 5 shows a perspective view of a further manner of securing the inner ring to the holding portion, and

FIG. 6 shows two views of still a further manner of securing the inner ring to the holding portion.

Referring to FIG. 1, shown therein is a simplified view of a radiant heating body for cooking hobs of twin-circuit heating arrangements. An insulating bottom 3 is inserted or laid into a holder bowl or dish 15 comprising a metal. In this case the insulating bottom 3 has annular limbs which project up to appropriately delimit the two heating circuits. Thus it can be seen that the assembly has on the one hand an outer ring limb 16 and an inner ring limb 17. In addition, a limb 18 extends diagonally through the inner circle. The outer ring 2 and the inner ring 1 are now fitted on to the limbs 16 and 17 of the insulating bottom. The heating conductors which in this case by way of example comprise a metal foil or sheet are denoted by reference 19. The entire twin-circuit heating arrangement is covered over by a glass ceramic plate 6 which lies on the top sides of the inner ring 1 and the outer ring 2. That affords heating circuits which are insulated from each other in terms of thermal engineering and which form on the one hand an outer heating circuit 20 and on the other hand an inner heating circuit 21.

The insulating bottom 3 like also the inner ring 1 and the outer ring 2 comprise a heat-insulating material, in a manner which is known per se from practice. The inner ring and the outer ring can be formed for example from a vermiculite. The insulating bottom 3 which is pressed into the holder dish or bowl 15 comprises a highly dispersed silica.

In the region of the outer ring limb 16 the bottom of the holder bowl or dish 15 is of a raised configuration, which means that the thickness of the insulating bottom 3 in the region of the outer ring limb 16 is approximately as large as in the remaining region. That affords numerous advantages, such as for example optimum compacting density in respect of the insulating bottom 3 which is produced from highly dispersed silica, a resiliency which remains the same after the compacting operation, optimum insulating properties and a low level of material consumption for the insulating bottom 3, together with enhanced stability of the holder bowl or dish 15 and orientation assistance and means for preventing rotary movement, when fitting the insulating bottom 3 in the holder bowl or dish 15.

FIG. 3 now shows the holding portion 4 for the inner ring 1. That holding portion 4 comprises a ring body with a limb extending centrally diagonally therethrough and is made from a suitable material, for example a plastic material. Provided at each of the transitions of the arcuate portions 4.1 to the diagonal central limb 4.2, at inward and outward positions, are substantially radially extending splits 4.3. Those splits 4.3 form a desired-rupture location. Both the arcuate portions 4.1 and also the central cross-section 4.2 have orifices 4.4.

The holding portion 4 now lies on the insulating bottom 3 or the corresponding limbs 17, with the inner ring 1 being fitted from above on to the holding portion 4. That structure can be particularly clearly seen from FIG. 2. It will also be apparent from FIG. 2 that a pin 5 is inserted into the inner ring and in securing the inner ring 1 projects through the holding portion 4 into the insulating bottom 3. In this arrangement the pin 5 can be pressed through the holding portion 4 or can project through an appropriate opening, as is identified in FIG. 3 by reference 4.4. The openings 4.4 permit relative movement of the components with respect to each other, as is inevitable due to the different coefficients of heat expansion.

FIG. 4 shows an inner ring 1 which is of a very thin cross-section. In the case of such an inner ring 1, a securing tongue or lug 8 is formed integrally thereon at the bottom side thereof and engages into a corresponding opening 10 in the holding portion 4. The securing tongue 8 has undercut configurations 8.1, thereby ensuring that it is securely fixed in the opening. At the same time there is a limited degree of mobility of the inner ring 1 with respect to the holding portion 4.

FIG. 5 shows an also very thin inner ring 1 with a securing tongue or lug 9 which is formed integrally thereon and which in this case is L-shaped. That securing tongue 9 is inserted into a corresponding opening 11 in the holding portion 4 and, by virtue of the undercut configuration 9.1, is on the one hand capable of fixedly connecting the inner ring 1 to the holding portion 4 while nonetheless permitting a certain amount of movement.

FIG. 2 shows that a pin 5 is inserted from beneath or from the bottom side into the inner ring. FIG. 6 now shows a similar structure with the pin 5 which in this case however is not inserted into the inner ring 1 from the bottom side but projects with its head end into a transverse bore 7 which extends parallel to the bottom side. That is the structure adopted for a very thin-walled inner ring 1. As shown at the right-hand side in FIG. 6 which is intended as a side or sectional view, the pin 5 is bent over at a right angle at its head end. In that way the head portion fits in the bore 7 in the inner ring 1. The shaft of the pin 5 is in turn fitted through the holding portion 4 into the insulating body or insulating bottom 3. In this case also the pin 5 can be passed through a closely fitting bore in the holding portion 4 or through a corresponding opening in the holding portion 4. The latter permits a relative movement between the holding portion 4 and the inner ring 1.

All details shown in the Figures and discussed in the description are important for the invention.

1. A radiant heating body for cooking hobs of twin-circuit heating arrangements, in particular glass ceramic cooking hobs, having heating conductors comprising a metal foil and insulating bottoms arranged under the heating conductors, wherein the heating conductors extend in a geometrical pattern between the respective cooking hob and the associated insulating bottom and the inner cooking hob of the twin-circuit heating arrangement is delimited by an inner ring of heat-insulating material, characterised in that the inner ring (1) and the outer ring (2) comprise components which are placed on the insulating bottom (3), that a holding portion (4) is inserted at least between the lower contact surface of the inner ring (1) and the facing annular surface of the insulating bottom (3), and that the inner ring is mechanically connected to the insulating bottom and/or the holding portion (4).

2. A radiant heating body according to claim 1 characterised in that the inner ring (1) is fixedly connected to the insulating bottom (3) by a pin (5) which is fixedly inserted at the bottom side and which passes through the holding portion (4).

3. A radiant heating body according to claim 1 or claim 2 characterised in that the holding portion (4) has a suitably large opening for receiving the pin (5) or a securing tongue (8, 9).

4. A radiant heating body according to claim 2 or claim 3 characterised in that the pin (5) is inserted into an opening which is provided in the bottom surface of the inner ring (1) and which is arranged substantially at a right angle to the holding portion (4) or the glass ceramic surface (6).

5. A radiant heating body according to one of claims 1 to 4 characterised in that the pin (5) is bent over at the head end and inserted into an opening (7) while the shaft is in turn passed perpendicularly through the holding portion (4) into the insulating bottom (3).

6. A radiant heating body according to claim 1 or claim 2 characterised in that the inner ring (1) has securing tongues (8, 9) which project at the bottom side, the securing tongues being fitted into corresponding openings (10, 11) through the holding portion (4) into the insulating bottom (3).

7. A radiant heating body according to claim 6 characterised in that the securing tongue (8) has a trapezoidal head which extends from a constricted neck portion.

8. A radiant heating body according to claim 7 characterised in that the securing tongues (9) are of an L-shaped configuration, wherein the lower longitudinal leg can be fitted into the opening (11) and the inner ring (1) is limitedly rotatable.

9. A radiant heating body according to claim 1 characterised in that the inner ring has a thin-walled cross-section of from about 0.3 to 1 mm.

10. A radiant heating body according to claim 1 characterised in that the holding portion (4) is formed from a straight central limb (12) which is adjoined at both sides by semicircular arcuate portions (12) which supplement each other to form a full circular ring.

11. A radiant heating body according to claim 1 or claim 10 characterised in that the holding portion (4) is produced in one piece and has cross-sectional weakenings formed therein at defined locations.
